(19) United States
(12) Patent Application Publication
(10) Pub. No.: US 2008/0165779 A1
(43) Pub. Date: Jul. 10, 2008

(54) Methods, devices, and computer program products for forwarding packets using experimental bits to support service provider applications

(76) Inventors: Walter Weiss, Douglasville, GA (US); Troy Meuninck, (US)

Correspondence Address: CANTOR COLBURN LLP - BELLSOUTH, 20 Church Street, 22nd Floor, Hartford, CT, 06103, US

(21) Appl. No.: 11/651,275

(22) Filed: Jan. 9, 2007

(51) Int. Cl. H04L 12/56

(52) U.S. Cl. 370/392; 370/401

(57) ABSTRACT

Forwarding packets using experimental bits to support service provider applications. An incoming packet is received. If the packet is associated with a service hosted by a service provider, the packet is forwarded using a packet marking associated with a predefined forwarding behavior applicable to the service hosted by the service provider. If the packet is not associated with a service hosted by the service provider, the packet is forwarded using a label marking associated with the packet.

### BACKGROUND

The present disclosure relates generally to communications networks and, more particularly, to methods, devices, and computer program products for forwarding packets using experimental bits to support service provider applications.

Multi-Protocol Label Switching (MPLS) is a technique for facilitating traffic flow in a communications network. Paths are established for each of a plurality of packets by applying a tag to each packet. This tag eliminates the need for a router to look up the address of a network node to which the packet should be forwarded, thereby saving time. MPLS is termed “multi-protocol” because MPLS is capable of operating in conjunction with internet protocol (IP), asynchronous transport mode (ATM), and frame relay network protocols. With reference to a standard network model referred to as open systems interconnection (OSI), MPLS allows most packets to be forwarded at a switching level (layer two) rather than at a routing level (layer 3).

In addition to facilitating traffic flow, MPLS provides techniques for managing quality of service (QoS) in a network. MPLS defines two QoS architectures for IP in the form of Integrated Services (IntServ) and Differentiated Services (DiffServ). IntServ defines a per-flow QoS, using resource reservation protocol (RSVP) as a signaling mechanism by which applications may request a desired QoS from the network. RSVP is a set of communication rules that allows channels or paths on the Internet to be reserved for multicast transmission of video and other high-bandwidth messages. In contrast to IntServ, DiffServ defines a QoS architecture based on flow aggregates. This architecture requires packet traffic to be conditioned and marked at network edges and internal nodes, so as to accord different QoS treatments to packets based on packet markings.

With reference to FIG. 1, an IP MPLS header 100 is a tag that is applied to a packet. This tag is used to forward traffic across an IP MPLS network. At each of a plurality of hops or nodes in the network, the tag is used for forwarding the packet to the next hop or node. This tag eliminates the need for a router to look up a packet route using IP V4 route lookup, thereby providing faster packet forwarding throughout a core area of the network not proximate to any external network.

IP MPLS header 100 includes a label marking in the form of a designated three-bit field, EXP bits 103. Although RFC 3032 describes EXP bits 103 as being reserved for experimental use, it would be misleading to assume that use of these bits is arbitrary or should be discouraged. For example, EXP bits 103 may be employed to define the QoS treatment (per-hop behavior) that a network node should apply to a packet. Additionally or alternatively, EXP bits 103 may be used to convey information encoded in a packet marking included within the packet.

One example of a packet marking is a DiffServ Code Point (DSCP) value used to mark packets that are routed in an internet protocol (IP) network. DSCP may be utilized to define a plurality of QoS classes as well a hierarchy of drop precedence within each class. In some applications, EXP bits 103 are used to carry information encoded in the IP DSCP. However, in other cases, EXP bits 103 are used exclusively to encode dropping precedence information.

In addition to EXP bits 103, IP MPLS header also includes a label value 101 of 20 bits, a stack bottom bit 105, and eight time to live bits 107. The functionalities of label value 101, stack bottom bit 105, and time to live bits 107 are described in greater detail in RFC 3032. As packets are forwarded across the network, label value 101 may be swapped (replaced by another label value) or popped (overwritten). When label value 101 is swapped, EXP bits 103 do not change. If a packet crosses into another network routing domain, then label value 101 is popped, a new label is written into label value 101, and the values of EXP bits 103 are not maintained. However, throughout a service provider network, all packets should maintain the values of EXP bits 103 from packet ingress to packet egress.

FIG. 2 is a prior art data structure diagram relating each of a plurality of service classes to EXP bits 103 (FIG. 1) and DSCP bits. A service provider may wish to offer customers the option of purchasing four classes of service, such as real time, interactive, business, and best effort. Each of these four classes of service are listed in forwarding equivalency class 201 field (FIG. 2), along with other required traffic categories such as internet protocol (IP) virtual private network (VPN) default, default, and network control. Each class of service listed in forwarding equivalency class 201 is associated with a corresponding DiffServ class name 203, a corresponding DSCP value 205, a corresponding EXP value 207 for EXP bits 103 (FIG. 1), and a description 209 (FIG. 2).

At present, router manufacturers offer platforms that can support as many as eight queues. Since EXP bits 103 (FIG. 1) includes three bits, this provides a maximum of eight unique label markings. However, a service provider may wish to offer four or more classes of traffic to internet protocol (IP) virtual private network (VPN) subscribers, thereby exhausting seven of these markings. With reference to FIG. 2, default traffic is associated with an EXP value 207 of 0, IP VPN default traffic is associated with an EXP value 207 of 1, business priority committed services are associated with an EXP value 207 of 2, and so on, with interactive services being associated with an EXP value 207 of 7. Accordingly, the data structure diagram of FIG. 2 clearly indicates that there is only one unused EXP value remaining—namely, an EXP value of 4. This leaves a maximum of one remaining label marking (an EXP value of 4) to differentiate between a multiplicity of services such as multicast internet protocol television (IPTV), unicast IPTV, video on demand (VOD), voice-based services, merchant on demand capabilities, and other communication services.

In order to support an increased number of forwarding classes at the edge of a service provider network proximate to one or more external networks, improved techniques for utilizing label markings such as EXP value 207 must be developed. What is needed is a technique for providing common QoS markings for all service provider hosted services in a core network while, at the same time, providing for differentiation of these services at a network edge. This technique should enable a differentiation between service provider hosted voice and network traffic representing voice.

### SUMMARY

Embodiments include methods, devices, and computer program products for forwarding packets using experimental bits to support service provider applications. The methods include receiving an incoming packet. If the packet is associated with a service hosted by a service provider, the packet is forwarded using a packet marking associated with a predefined forwarding behavior applicable to the service hosted by the service provider. If the packet is not associated with a service hosted by the service provider, the packet is forwarded using a label marking associated with the packet.

Embodiments further include computer program products for implementing the foregoing methods. Additional embodiments include a device for receiving an incoming packet. The device includes a packet receiving mechanism for receiving a packet, and a packet routing mechanism coupled to the packet receiving mechanism. If a packet received by the receiving mechanism is associated with a service hosted by a service provider, the routing mechanism forwards the packet using a packet marking associated with a predefined forwarding behavior applicable to the service hosted by the service provider. If the packet received by the receiving mechanism does not correspond to a service offered by the service provider, the routing mechanism forwards the packet using a label marking associated with the packet.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is a prior art data structure diagram illustrating a packet header.

FIG. 2 is a prior art data structure diagram relating each of a plurality of service classes to EXP bits and DSCP bits.

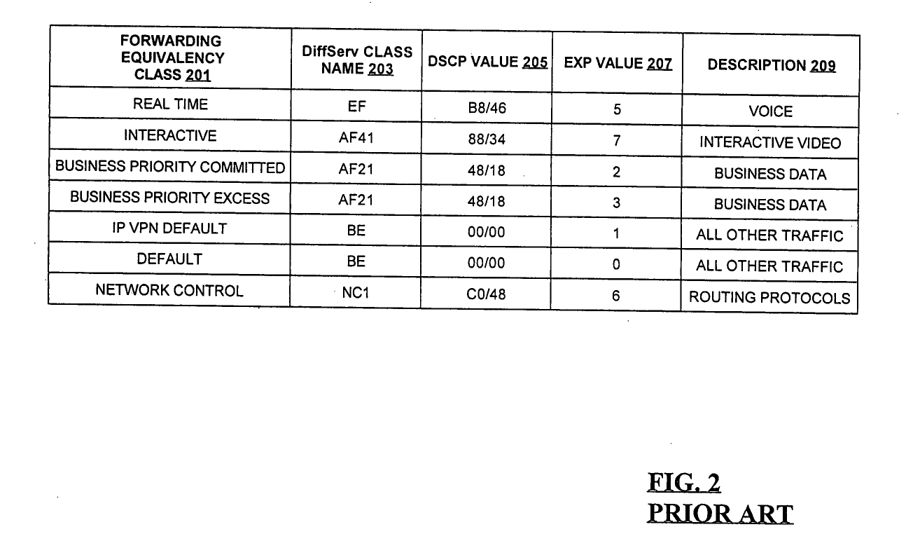

FIG. 3 is a data structure diagram relating each of a plurality of illustrative service classes to EXP bits and DSCP bits according to an exemplary set of techniques for forwarding packets using experimental bits to support service provider applications.

FIG. 4 is a flowchart setting forth illustrative methods for forwarding packets using experimental bits to support service provider applications.

FIG. 5 is a diagram setting forth a first illustrative data flow by which packets are forwarded using experimental bits to support service provider applications.

FIG. 6 is a diagram setting forth a second illustrative data flow by which packets are forwarded using experimental bits to support service provider applications.

FIG. 7 is a diagram setting forth a third illustrative data flow by which packets are forwarded using experimental bits to support service provider applications.

FIG. 8 is a diagram setting forth a fourth illustrative data flow by which packets are forwarded using experimental bits to support service provider applications.

FIG. 9 is a diagram setting forth a fifth illustrative data flow by which packets are forwarded using experimental bits to support service provider applications.

FIG. 10 is a diagram setting forth a sixth illustrative data flow by which packets are forwarded using experimental bits to support service provider applications.

The detailed description explains exemplary embodiments of the invention, together with advantages and features, by way of example with reference to the drawings.

### DETAILED DESCRIPTION OF EXEMPLARY EMBODIMENTS

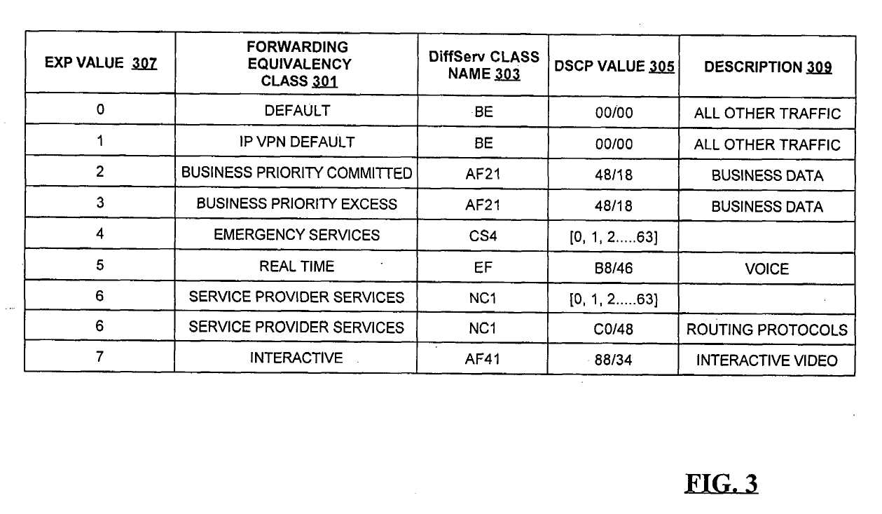

FIG. 3 is a data structure diagram relating each of a plurality of illustrative service classes to EXP bits and DSCP bits according to an exemplary set of techniques for forwarding packets using experimental bits to support service provider applications. EXP bits may be conceptualized as label markings, whereas DSCP bits may be conceptualized as packet markings included in the contents of a packet. Each of a plurality of EXP values in an EXP value 307 field is associated with a corresponding forwarding equivalency class 301, a corresponding DiffServ class name 303, a corresponding DSCP value 305, and a corresponding description 309. For example, an EXP value 307 of 0 is associated with a forwarding equivalency class 301 of default, a DiffServ class name 303 of BE, a DSCP value 305 of 00/00, and a description 309 of “all other traffic”. Likewise, an EXP value 307 of 3 is associated with a forwarding equivalency class 301 of business priority excess, a DiffServ class name 303 of AF21, a DSCP value 305 of 48/18, and a description 309 of “business data”.

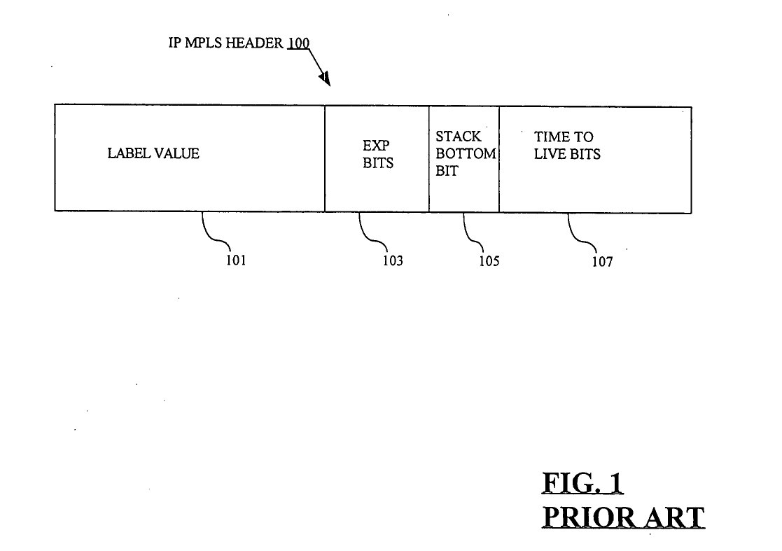

The data structure diagram of FIG. 3 shows overloading of EXP bits 103 (FIG. 1) so as to enable a service provider to support an increased number of forwarding classes at the edge of the service provider network. In the example of FIG. 3, there are two special classes of overloading identified in the core network. These two classes are identified by an EXP value 207 of 4 or 6. With reference to an EXP value 207 of 6, note that a DSCP value 205 of decimal 48 is identified as a service provider routing protocol service. Accordingly, by using one EXP value in the core of the service provider network, such as an EXP value 207 of 6, a set of services hosted by a service provider can receive special treatment in the core. This set of services, corresponding to DSCP values 205 from 0 to 63 (inclusive), could be defined to meet the needs of specific system applications.

RFC 3270, entitled “Multi-Protocol Label Switching Support of Differentiated Services”, outlines three models for delivering traffic across an IP MPLS network. These are short pipe, long pipe, and uniform. In uniform mode, a label marking (such as EXP value 307, FIG. 3) reflects the contents of a packet. The network treats packet traffic as if the label marking did not exist. The label marking is treated in the same manner as the packet contents, with the effect that traffic is treated the same at every hop or node in the network, including hops or nodes at network egress points.

Pursuant to the long pipe model, the label marking (EXP value 307, FIG. 3) reflects a desired per-hop behavior within the network. This per-hop behavior specifies the manner in which the packet is to be treated by the network. Upon presentation of a packet to the network for forwarding, an appropriate per-hop behavior is determined for the packet and an appropriate label marking is applied to the packet. Upon egress from the network, the packet is treated in accordance with the applied label marking. For example, if a packet marking within the packet (such as DSCP value 305, FIG. 3) is 3 and the applied label marking is 4, the packet will be treated with a per hop behavior that is associated with a packet having a label marking of 4, including any egress treatment associated with this label marking.

In the short pipe model, the label marking reflects the desired per hop behavior within the network and defines the manner in which the packet is to be treated within the network. Upon presentation of a packet to the network for forwarding, an appropriate per hop behavior is determined for the packet and an appropriate label marking is applied to the packet. Upon egress from the network, the packet is treated in accordance with a packet marking in the packet contents, and not in accordance with the label marking. For example, if a packet marking in the form of DSCP value 305 is 3, with a label marking in the form of EXP value 307 of 4, then the packet will be treated with the per hop behavior associated with a marking of 4 within the network. Upon egress from the network, the packet will be treated with the per hop behavior associated with a marking of 3.

Network routers generally implement a penultimate hop popping (PHP) scheme, signifying that packets are not forwarded to a destination router with a label value 101 (FIG. 1). The destination router is the last router of a sequence of routers on a network through which a packet is to be routed. In many situations, there is no need for label value 101 because, once the destination router receives the packet, the destination router needs to look up a packet route in a routing table to forward the packet appropriately. The destination router will not have access to information included in label value 101. If a desired behavior is to forward the packet out of the network based upon label value 101 (i.e., long pipe or short pipe model), then the destination router must have access to information included in the label. The destination router can issue a request for an upstream router to send a labeled packet. Due to the fact that there is no label path out of the destination router, the upstream router will place a null value in label value 101. This process is termed “explicit null”. However, EXP bits 103 may be employed to maintain the necessary packet forwarding information so that the destination router will forward the packet using the label markings and not the packet markings.

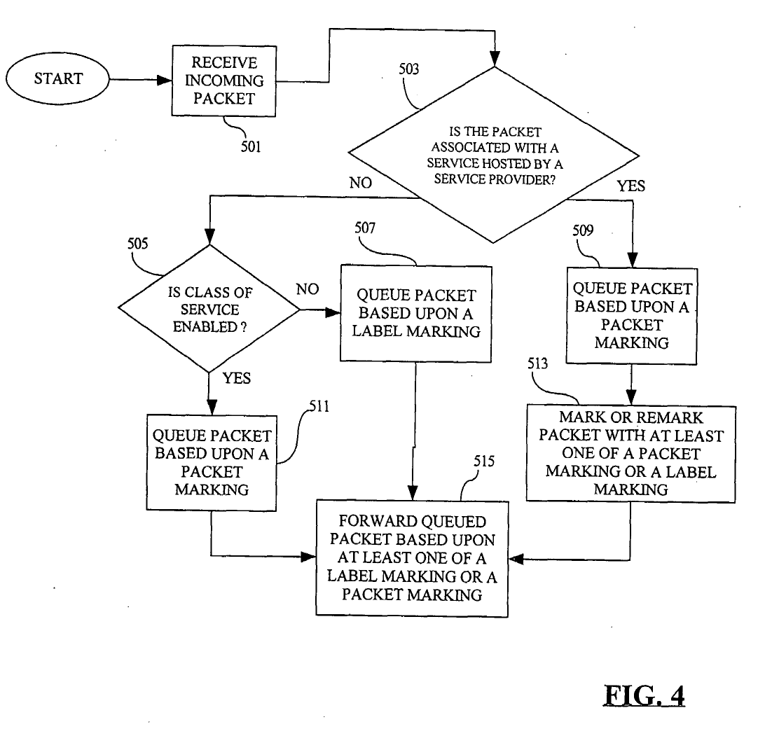

FIG. 4 is a flowchart setting forth illustrative methods for forwarding packets using experimental bits to support service provider applications. The procedure commences at block 501 where an incoming packet is received. A test is performed at block 503 to ascertain whether or not the packet is associated with a service hosted by a service provider. If so, the packet is queued based upon a packet marking contained within the packet such as the DSCP value 305 (FIG. 3) of the packet (FIG. 4, block 509). The packet is then marked or remarked with at least one of a DSCP value, an EXP value 307 (FIG. 3), an IP Precedence value, or 802.1p bits (FIG. 4, block 513). The queued packet is forwarded based upon at least one of a packet marking or a label marking (block 515). The packet marking or label marking may include one or more of the DSCP value, EXP value, IP Precedence value, or 802.1p bits.

The negative branch from block 503 (FIG. 4) leads to block 505 where a test is performed to ascertain whether or not a class of service feature offered by a service provider is enabled. If not, the procedure advances to block 507 where the packet is queued based upon a label marking such as the EXP value 307 (FIG. 3) of the packet. The affirmative branch from block 505 (FIG. 4) leads to block 511 where the packet is queued based upon a packet marking contained within the packet such as the DSCP value 305 (FIG. 3). The procedure then advances to block 515 (FIG. 4) where the queued packet is forwarded based upon at least one of a packet marking or a label marking. The packet marking or label marking may include one or more of the DSCP value, EXP value, IP Precedence value, or 802.1p bits.

The methods set forth in FIG. 4 provide sufficient flexibility for implementing desired packet forwarding behaviors across a broad range of service provider networks. For example, in a first scenario, a customer purchases dedicated Internet access from a service provider but does not purchase a class of service feature from that service provider. On ingress to the service provider network, an EXP value of 0 is assigned to EXP bits 103 (FIG. 1) indicating that this customer's traffic is not accorded any special treatment. This EXP label marking of 0 is maintained throughout the network. When the packet arrives at a final egress router on the service provider network, the packet is forwarded in class-default based upon its EXP label marking of 0. This egress behavior is symmetrical and utilizes long pipe mode.

Pursuant to a second scenario, a customer purchases IP VPN service with four classes of service from a service provider. On ingress to the service provider network, packet traffic is metered and conforming traffic is assigned an appropriate EXP label marking. Traffic that is nonconforming is assigned a default EXP label marking. On egress from the service provider network, traffic is forwarded using the customer's original label marking. The egress behavior is symmetrical and uses short pipe mode.

Pursuant to a third scenario, a customer purchases regular internet access with no class of service feature from a service provider. The customer also purchases Voice over Internet Protocol (VoIP) service and Internet Protocol Television (IPTV) service, both of which are hosted by the service provider. When this customer sends Internet traffic, it is assigned an EXP label marking of 0, signifying that such Internet traffic will receive no special treatment in the service provider core network. When the customer initiates a voice call, packets associated with the voice call are marked with an EXP label marking of 6. These packets are forwarded through the network. The Internet traffic egresses the network based upon the label marking of 0 and receives default class treatment. The voice call traffic egresses the network based upon the packet marking (such as DSCP value 305).

On receipt of traffic destined for the customer in the third scenario, regular Internet traffic should exit his local serving egress router with treatment corresponding to an EXP label marking of 0. Voice service traffic should exit as real time traffic based upon the packet marking such as the DSCP value. Video traffic should exit as interactive based DSCP values. The destination router must deliver some traffic out of a customer interface based upon the long pipe model, and other traffic out of the customer interface based upon the short pipe model. If one or more services hosted by the service provider is involved, the destination router must treat these services uniquely while, at the same time, lumping all other traffic together. One example for applying the operational sequence of FIG. 4 to the third scenario is that a voice packet from another VoIP provider (not the aforementioned service provider) that comes in over regular Internet with the same markings as a service provider hosted service would not receive special egress treatment, but packets corresponding to the service provider hosted service would receive special egress treatment. These behaviors require that egress equipment be capable of supporting long pipe, short pipe, and a combination of short and long pipe, all on the same interface.

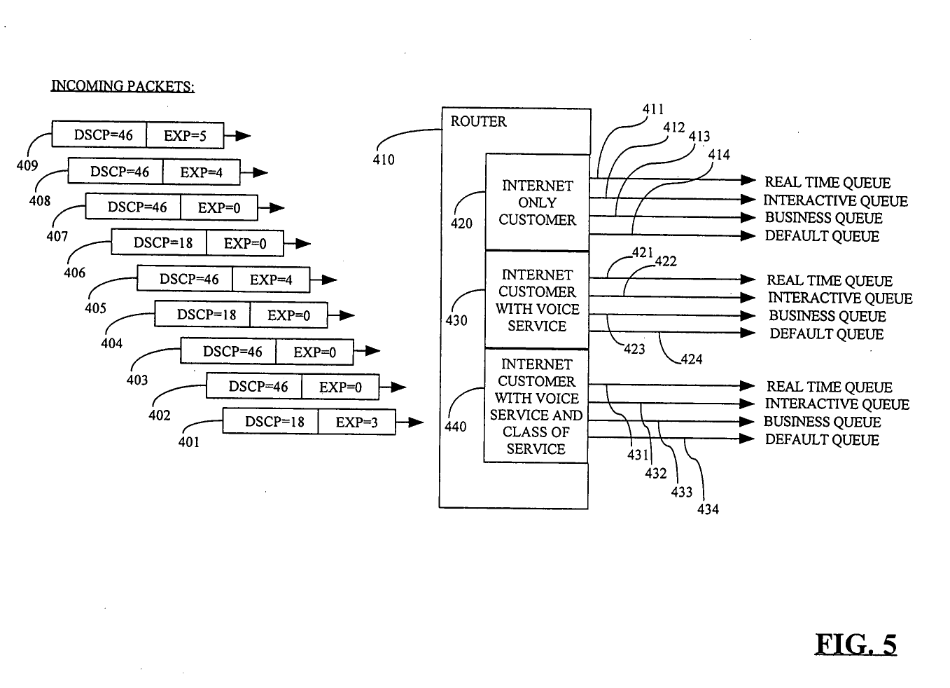

FIG. 5 is a diagram setting forth a first illustrative data flow by which packets are forwarded using experimental bits to support one or more services hosted by a service provider. The one or more services hosted by the service provider may represent a retail service, a wholesale service, or a combination of a retail service and a wholesale service. Moreover, a service provider may host n services (n being a positive integer greater than one) with one of the n services being a wholesale service in conjunction with n−1 retail services. In this manner, a service provider can wholesale QOS support to another provider.

For purposes of illustration, a service provider may represent a retailer selling voice over internet protocol (VoIP) services to small businesses such as “Company X”. Furthermore, assume that Company X wishes to offer voice service to customers using the service provider's wholesale bandwidth. The service provider would offer Company X a class of service feature on this wholesale bandwidth wherein the service provider would honor Company X's label markings (EXP bits) and tunnel packets bearing these label markings through the service provider's network. Accordingly, it is possible to utilize a portion of the wholesale bandwidth to support voice (or other) services.

In addition to or in lieu of functioning as a retailer, the service provider may function as a wholesaler of bandwidth. In this manner, the service provider sells bandwidth to other service providers that use the bandwidth to provide competing services. For example, assume that a wholesale service provider sells bandwidth to service provider A and service provider B. Using the techniques described herein, the wholesale provider maps label markings (EXP bits) of packets received from service provider A into a standard EXP marking. On the edge of the service provider network at an egress access circuit, the wholesale provider provides differentiated services to service provider A based upon the label markings from service provider A. The wholesale service provider can use the same label markings (EXP bits) to provide different services to packets from service provider B. The wholesale service provider can assign appropriate egress policies to these label markings based upon wholesale customer (or service provider) rules.

Packet traffic destined for any of three different types of customers is received at an egress router 410. The packet traffic includes a first packet 401, a second packet 402, a third packet 403, a fourth packet 404, a fifth packet 405, a sixth packet 406, a seventh packet 407, an eighth packet 408, and a ninth packet 409.

Illustratively, the three different types of customers are an internet only customer 420, an internet customer with voice service 430, and an internet customer with voice service and class of service 440. Three different types of customers are shown for illustrative purposes only, it being understood that fewer types of customers may be provided, or more types of customers may be provided, depending upon the requirements of specific system applications. Moreover, each type of customer may include one or more customers. A first type of customer may include a fewer or a greater number of customers than a second type of customer. However, for illustrative purposes, it will be assumed that each type of customer 420, 430, 440 shown in FIGS. 5-10 includes one customer.

Four types of queues are provided for each customer. Internet only customer 420 is provided with a real time queue 411, an interactive queue 412, a business queue 413, and a default queue 414. Similarly, internet customer with voice service 430 is provided with a real time queue 421, an interactive queue 422, a business queue 423, and a default queue 424. Likewise, internet customer with voice service and class of service 430 is provided with a real time queue 431, an interactive queue 432, a business queue 433, and a default queue 434.

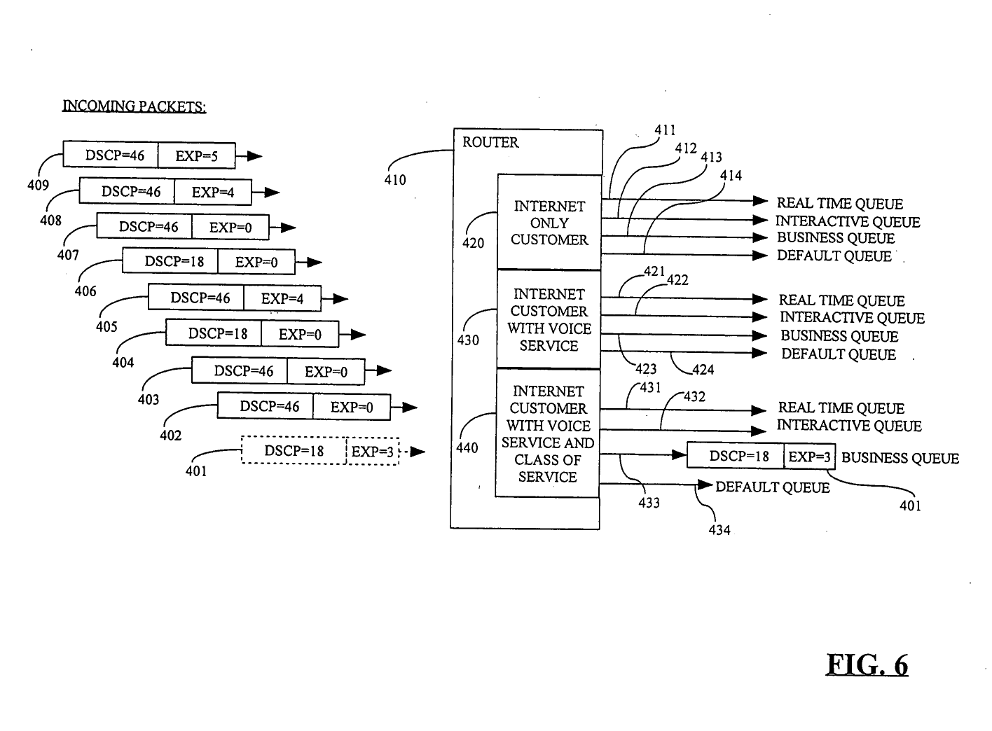

Referring now to FIG. 6, assume that router 410 receives first packet 401. First packet 401 is destined for internet customer with voice service and class of service 440. The first packet includes a label marking (EXP value) of 3 and a packet marking (DSCP value) of 18. Accordingly, router 410 places first packet 401 into business queue 433 of internet customer with voice service and class of service 430 based upon the packet marking of 18. This forwarding behavior uses the short pipe model.

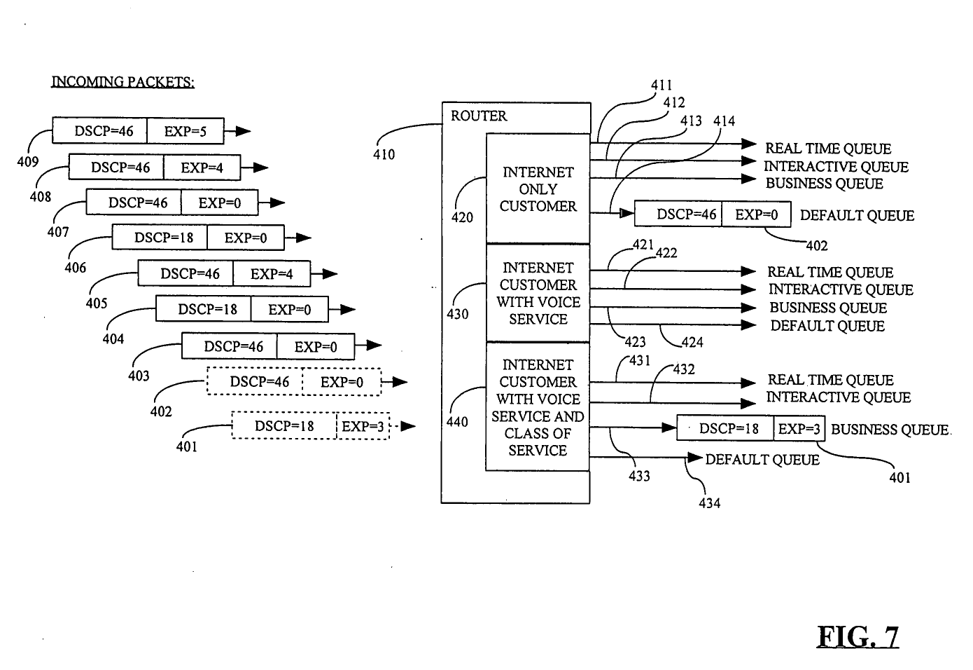

Next, router 410 receives second packet 402. With reference to FIG. 7, second packet 402 is a voice packet from a service that is not hosted by the service provider. Second packet 402 is destined for internet only customer 420 who has not purchased a class of service feature. Accordingly, second packet 402 is placed into default queue 414 of internet only customer 420. Second packet 402 has a packet marking (DSCP value) of 46 which is correct for voice, but the packet is being scheduled out using the long pipe model.

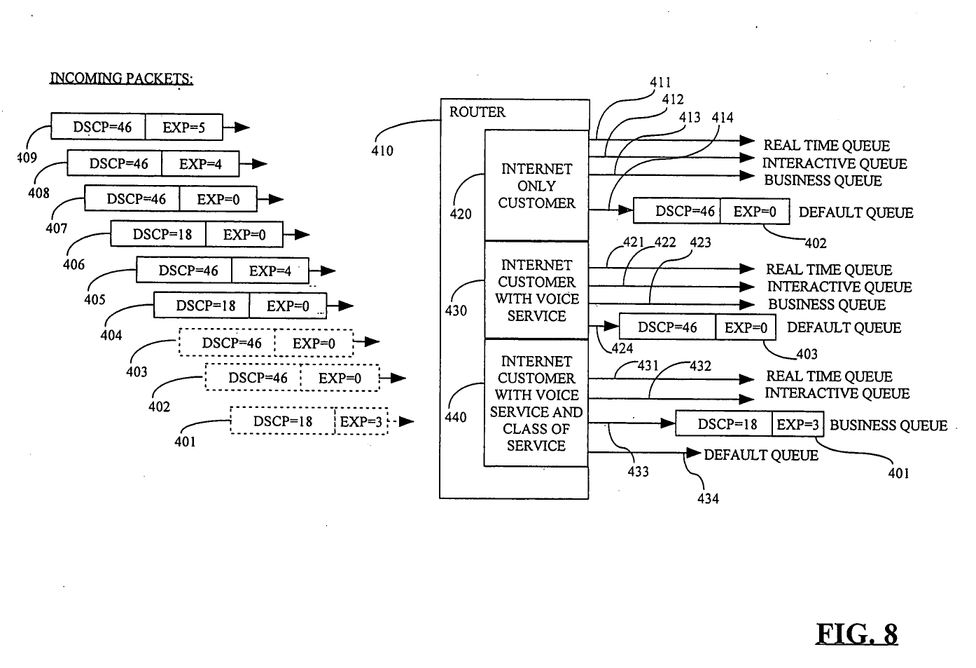

Third packet 403 is then received at router 410. Referring now to FIG. 8, third packet 403 is a voice packet from a service that is not hosted by the service provider. Third packet 403 is destined for internet customer with voice service 430. This customer has not purchased the class of service feature. Accordingly, third packet 403 is placed into default queue 424 of internet customer with voice service 430. Third packet 403 has a packet marking (DSCP value) of 46 which is correct for voice, but the packet is being scheduled out using the long pipe model.

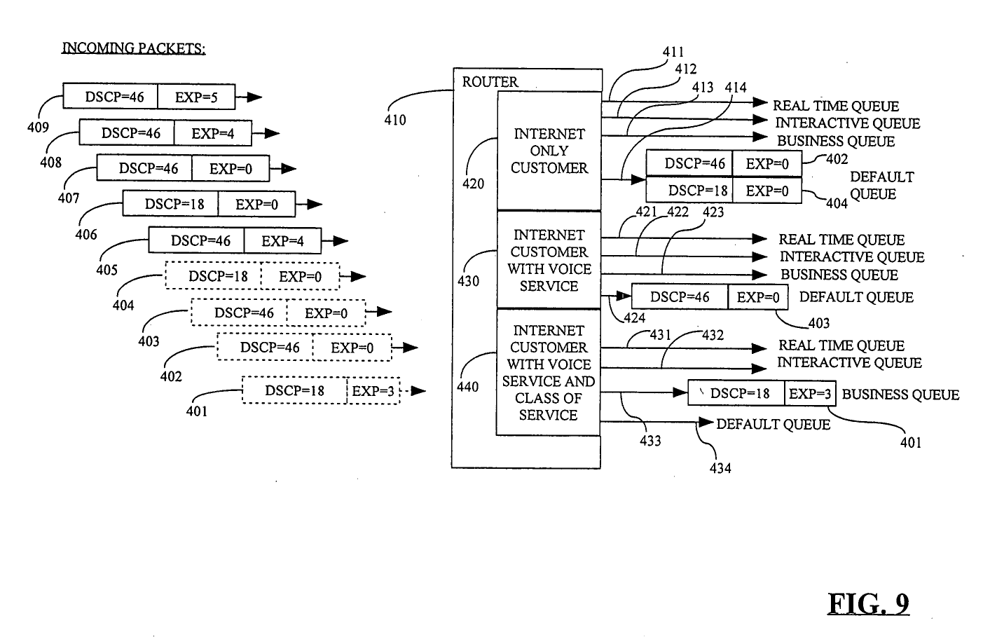

With reference to FIG. 9, fourth packet 404 arrives at router 410. Fourth packet 404 includes a packet marking (DSCP value) of 18, indicating that this packet is a business packet. However, since fourth packet 404 originated from a customer that did not purchase the class of service feature, the label marking (EXP value) of fourth packet 404 is 0. Accordingly, fourth packet 404 will be scheduled out using the long pipe model.

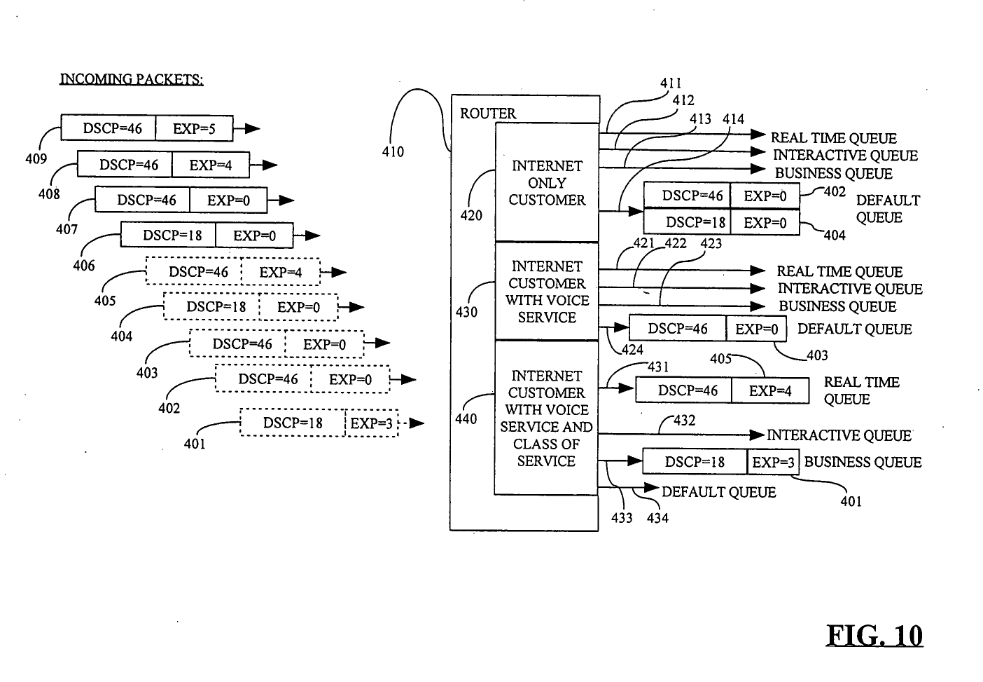

Referring now to FIG. 10, fifth packet 405 arrives at router 410. Fifth packet 404 includes a label marking (EXP value) of 4, indicating that this packet is associated with a service hosted by the service provider. The packet marking (DSCP value) is 46 which indicates voice. This packet will be scheduled out using the short pipe model and placed into real time queue 431 of internet customer with voice service and class of service 440.

The examples presented in FIGS. 5-10 illustrate the different treatments applied to different packets based upon two factors. The first factor is the level of service that the customer is entitled to receive based upon the type of access purchased by the customer (internet only, class of service, etc). The second factor is whether or not a packet being delivered is associated with a service hosted by the service provider. If the packet is associated with a service hosted by the service provider, then the second factor will override the first factor.

In addition to being able to schedule packets out based upon whether the packets are part of a service provider hosted service, it is also necessary to be able to change the markings of these packets. These markings could be an EXP value, a DSCP value, 802.1p bits, or IP Precedence bits. The reason for remarking the packets is that there may be a downstream router or other device that cannot schedule packets dynamically using long pipe and short pipe. Therefore, when the egress router forwards the packets, the egress router needs to provide the downstream device with sufficient information so that the downstream device can properly forward the packets. For example, a first router recognizes a packet corresponding to a service provider hosted service and forwards the packet to a second router based upon a DSCP value included in the packet. The second router is capable of routing the packet only using 802.1p bits, and not DSCP. Accordingly, the first router must remark the packet with the correct 802.1p bit marking, so that the second router can forward the packet correctly. The second router should forward the packet in a service provider hosted service queue.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of forwarding packets using experimental bits to support service provider applications, the method comprising:
receiving an incoming packet;
if the packet is associated with a service hosted by a service provider, then forwarding the packet using a packet marking associated with a predefined forwarding behavior applicable to the service hosted by the service provider; and
if the packet is not associated with a service hosted by the service provider, then forwarding the packet using a label marking associated with the packet.

2. The method of claim 1 wherein the packet marking includes a DiffServ Code Point (DSCP) value.

3. The method of claim 1 wherein the label marking includes one or more experimental (EXP) bits.

4. The method of claim 3 wherein the service provider hosts a plurality of services including at least a retail service, a wholesale service, or a combination of a retail service and a wholesale service.

5. The method of claim 4 wherein the service provider is a retailer selling voice over internet protocol (VoIP) service to a third party, and the third party offers VoIP service to customers using a service provider network.

6. The method of claim 5 wherein the service provider offers the third party a class of service feature on the service provider network wherein the service provider honors third party label markings and tunnels packets bearing these label markings through the service provider network.

7. The method of claim 4 wherein the service provider is a wholesale service provider of bandwidth such that the service provider sells bandwidth on the service provider network to one or more other service providers.

8. The method of claim 7 wherein the other service providers include a first service provider and a second service provider, and the wholesale service provider maps label markings of packets received from the first service provider into the EXP bits;
such that, at an edge of the service provider network, the wholesale service provider provides a first set of one or more services to the first service provider based upon the label markings of packets received from the first service provider and,
such that, at an edge of the service provider network, the wholesale service provider provides a second set of one or more services to the second service provider based upon the label markings of packets received from the second service provider, wherein the first set of one or more services is not identical to the second set of one or more services.

9. The method of claim 1 further comprising providing a class of service feature which, when enabled, queues one or more packets based upon the packet marking and, when not enabled, queues one or more packets based upon the label marking.

10. The method of claim 9 further comprising the service provider providing the class of service feature to another service provider.

11. The method of claim 1 further comprising remarking the packet with at least one of a new label marking or a new packet marking if the packet is to be forwarded using a packet marking associated with a predefined forwarding behavior applicable to the service hosted by the service provider.

12. The method of claim 1 further comprising the service provider offering at least four different classes of service.

13. The method of claim 12 wherein the at least four different classes of service comprise real time service, interactive service, best effort service, and business service.

14. A computer program product for forwarding packets using experimental bits to support service provider applications, the computer program product comprising a storage medium readable by a processing circuit and storing instructions for execution by the processing circuit for facilitating a method comprising:
receiving an incoming packet;
if the packet is associated with a service hosted by a service provider, then forwarding the packet using a packet marking associated with a predefined forwarding behavior applicable to the service hosted by the service provider; and
if the packet is not associated with a service hosted by the service provider, then forwarding the packet using a label marking associated with the packet.

15. The computer program product of claim 14 wherein the packet marking includes a DiffServ Code Point (DSCP) value.

16. The computer program product of claim 14 wherein the label marking includes one or more experimental (EXP) bits.

17. The computer program product of claim 16 wherein the service provider hosts a plurality of services including at least a retail service, a wholesale service, or a combination of a retail service and a wholesale service.

18. The computer program product of claim 17 wherein the service provider is a retailer selling voice over internet protocol (VoIP) service to a third party, and the third party offers VoIP service to customers using a service provider network.

19. The computer program product of claim 18 wherein the service provider offers the third party a class of service feature on the service provider network wherein the service provider honors third party label markings and tunnels packets bearing these label markings through the service provider network.

20. The computer program product of claim 17 wherein the service provider is a wholesale service provider of bandwidth such that the service provider sells bandwidth on the service provider network to one or more other service providers.

21. The computer program product of claim 20 wherein the other service providers include a first service provider and a second service provider, and the wholesale service provider maps label markings of packets received from the first service provider into the EXP bits;
such that, at an edge of the service provider network, the wholesale service provider provides a first set of one or more services to the first service provider based upon the label markings of packets received from the first service provider and,
such that, at an edge of the service provider network, the wholesale service provider provides a second set of one or more services to the second service provider based upon the label markings of packets received from the second service provider, wherein the first set of one or more services is not identical to the second set of one or more services.

22. The computer program product of claim 14 further comprising instructions for providing a class of service feature which, when enabled, queues one or more packets based upon the packet marking and, when not enabled, queues one or more packets based upon the label marking.

23. The computer program product of claim 22 wherein the service provider provides the class of service feature to another service provider.

24. The computer program product of claim 14 further comprising instructions for remarking the packet with at least one of a new label marking or a new packet marking if the packet is to be forwarded using a packet marking associated with a predefined forwarding behavior applicable to the service hosted by the service provider.

25. The computer program product of claim 14 further comprising the service provider offering at least four different classes of service.

26. The computer program product of claim 25 wherein the at least four different classes of service comprise real time service, interactive service, best effort service, and business service.

27. A device for receiving an incoming packet, the device comprising:
a packet receiving mechanism for receiving a packet; and
a packet routing mechanism coupled to the packet receiving mechanism;
wherein, if a packet received by the receiving mechanism is associated with a service hosted by a service provider, the routing mechanism forwards the packet using a packet marking associated with a predefined forwarding behavior applicable to the service hosted by the service provider and, if the packet received by the receiving mechanism does not correspond to a service offered by the service provider, the routing mechanism forwards the packet using a label marking associated with the packet.

28. The device of claim 27 wherein the packet marking includes a DiffServ Code Point (DSCP) value.

29. The device of claim 27 wherein the label marking includes one or more experimental (EXP) bits.

30. The device of claim 29 wherein the service provider hosts a plurality of services including at least a retail service, a wholesale service, or a combination of a retail service and a wholesale service.

31. The device of claim 30 wherein the service provider is a retailer selling voice over internet protocol (VoIP) service to a third party, and the third party offers VoIP service to customers using a service provider network.

32. The device of claim 31 wherein the service provider offers the third party a class of service feature on the service provider network wherein the service provider honors third party label markings and tunnels packets bearing these label markings through the service provider network.

33. The device of claim 30 wherein the service provider is a wholesale service provider of bandwidth such that the service provider sells bandwidth on the service provider network to one or more other service providers.

34. The device of claim 33 wherein the other service providers include a first service provider and a second service provider, and the wholesale service provider maps label markings of packets received from the first service provider into the EXP bits;
such that, at an edge of the service provider network, the wholesale service provider provides a first set of one or more services to the first service provider based upon the label markings of packets received from the first service provider and,
such that, at an edge of the service provider network, the wholesale service provider provides a second set of one or more services to the second service provider based upon the label markings of packets received from the second service provider, wherein the first set of one or more services is not identical to the second set of one or more services.

35. The device of claim 27 wherein the routing mechanism implements a class of service feature which, when enabled, queues one or more packets based upon the packet marking and, when not enabled, queues one or more packets based upon the label marking.

36. The device of claim 35 further comprising the service provider providing the class of service feature to another service provider.

37. The device of claim 27 wherein the routing mechanism remarks the packet with at least one of a new label marking or a new packet marking if the packet is to be forwarded using a packet marking associated with a predefined forwarding behavior applicable to the service hosted by the service provider.
